(19) United States
(12) Patent Application Publication
(10) Pub. No.: US 2007/0080791 A1
(43) Pub. Date: Apr. 12, 2007

(54) Tactile device

(76) Inventor: Joseph Klaparda, Las Vegas, NV (US)

Correspondence Address: Phil Virga, #105, 1525 Aviation Blvd., Redondo Beach, CA, 90278, US

(21) Appl. No.: 11/215,712

(22) Filed: Aug. 29, 2005

(51) Int. Cl. H04B 3/36

(52) U.S. Cl. 340/407.1

(57) ABSTRACT

A tactile device that may make different sounds and vibrations during shaking, rotation, or sliding back and forth between the hands of a user or when attached to a user's limb or appendage. The device comprises a flexible mesh housing having a plurality of musically-pleasing sound producing members so that oscillation or other movement of the housing causes the members to impinge upon each other, thereby, producing sounds and vibrations. An adjustable strap member is attached to the housing for ease of handling the device during use and for storage purposes.

### BACKGROUND

1. Field of the Invention

The present invention relates in general to a tactile device which may be hand-held or attached to any limb or appendage of the body and, more particularly, to a tactile device which may be manipulated by the user for communication, interaction with others, entertainment, and/or relaxation.

2. Description of the Related Art

A variety of hand-held objects, toys and the like are available for the entertainment and/or relaxation of the user. One such class of objects is tactile devices that generally consist of resilient materials that may be manipulated or squeezed by the user. The action of squeezing the object is intended to relax the user or provide tactile stimulation. However, these objects may not be used as an effective means of communication or interaction for individuals with disabilities or for those who wish to stimulate a sense of touch or sound.

Therefore, a tactile device which may be used for people with disability and a degenerating handicap and/or severely autistic children which allows them to communicate or interact with themselves and others through tactile signals, is desirable.

### SUMMARY

It is an object of the present to provide a tactile device that may make different sounds and vibrations during shaking, rotation or sliding back and forth between the hands of a user or when attached to a limb or user's appendage.

It is a further object of the present invention to provide a tactile device that can produce a wide variety of sounds while simultaneously letting the sounds escape in real time into the surrounding environment without attenuation of the sound by the tactile device.

In the present invention, a flexible mesh housing contains a plurality of musically-pleasing sound producing members so that oscillation or other movement of the housing causes the members to impinge upon each other, thereby producing said sound or vibration. An adjustable strap member is affixed to the top of the housing for ease of handling the device during use and for storage purposes. The flexible mesh housing may be made out of a number of materials including cloth, nylon, plastic material, cotton string or a thin wire metal, and the sound producing members may be either clear crystal marbles, rose teak balls or steel ball bearings.

### BRIEF DESCRIPTION OF THE DRAWINGS

The above, as well as other, advantages of the present invention will become readily apparent to those skilled in the art from the following detailed description of the preferred embodiments when considered in the light of the accompanying drawings in which:

FIG. 1 is an isometric view of the tactile device of the present invention.

FIG. 2 is an isometric view of the tactile device being slide back and forth between the hands of a user in accordance with the present invention.

FIGS. 3 is an isometric view of the tactile device being shaked in a closed position of the hand of a user in accordance with the present invention.

FIGS. 4 is an isometric view of the tactile device being shaked and rotated between the hands of a user in accordance with the present invention.

FIGS. 5 is an isometric view of the tactile device being tumbled in the open hand of a user in accordance with the present invention.

### DETAILED DESCRIPTION

Referring now to the drawings wherein like reference numerals refer to like and corresponding parts throughout, the tactile device is generally indicated by numeral 10. Referring now to FIG. 1, the tactile device 10 comprises a flexible mesh housing 12 formed by a cloth-like material. The flexible mesh housing 12 forms a plurality of openings or meshes 16, wherein a plurality of musically-pleasing sound producing members 18 are housed. By way of example but not of limitation the cloth-like material may include cloth, nylon, plastic material and the like. Although not shown it may also be envisioned that the flexible mesh housing 12 be made from individual filaments or strings. The individual filaments or strings are connected to one another at spaced points of attachment to form a plurality of 30 opening or meshes 16, wherein a plurality of musically-pleasing sound producing members 18 are contained.

The flexible mesh housing 12 is permanently closed after placement of the musically-pleasing sound producing members 18 by stitching together the mesh housing or by any closure means known in the art. Referring once again to FIG. 1, in the preferred embodiment the flexible mesh housing 12 is closed by hook and strap means or Velcro 14 for access to the musically-pleasing sound members 18 in the event the user wishes to change the sound or the vibration properties of members 18.

As shown in FIG. 1, a strap 22 is affixed to the top of flexible mesh housing 12 and sized to fit loosely over the hand of a user or for attachment to any limb or appendage for ease of handling during use of the tactile device 10. The strap 22 is adjustable to fit the hand, limb or appendage of the user by the use of hook and strap means or Velcro 24. When not in use, the strap 22 may be used to hang the tactile device 10 nearby for convenience or used later in storage.

Although not shown it may be envisioned that the flexible mesh housing 12 be made from individual filaments or strings made of a plastic material such as polystyrene although it is to understood that it is within the scope of this invention to utilize other materials such as cotton string or fine metal wire provided that adequate sound or vibration levels can be generated therewith. The flexible mesh housing 12 comprises a tubular body member illustrated in the present embodiment as being semi-cylindrical, although it is to be understood that other shapes could also be used such as elliptical or spherical.

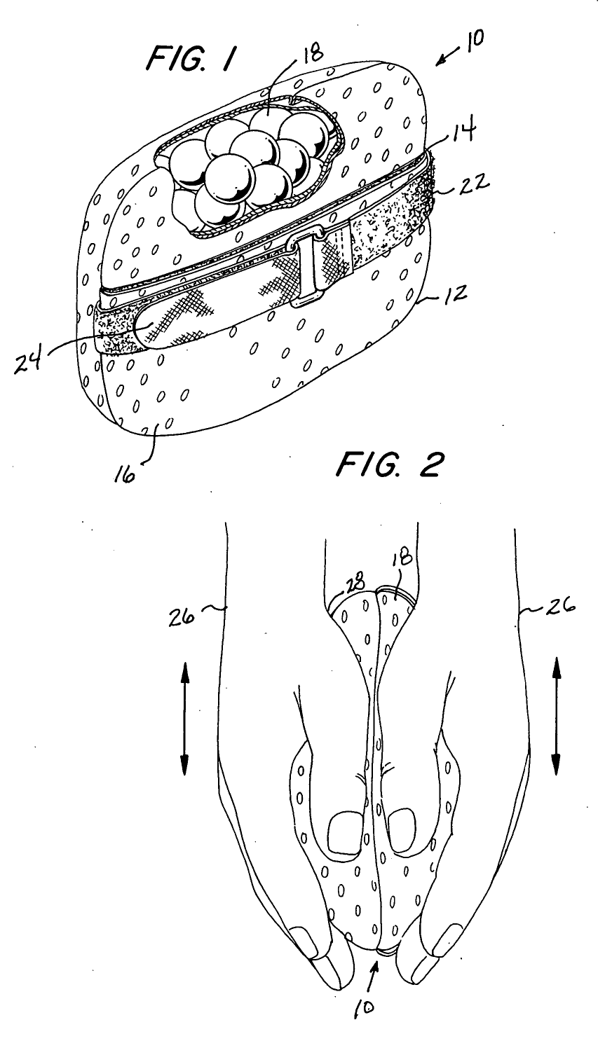

Referring now to FIG. 2, in one type of operation, the tactile device 10 may be hand-held wherein it is slid back and forth between the palms 28 of a user's hands 26. In such an operation, sound producing members 18 will slide along each other producing a sound and vibration comparable to a maracas.

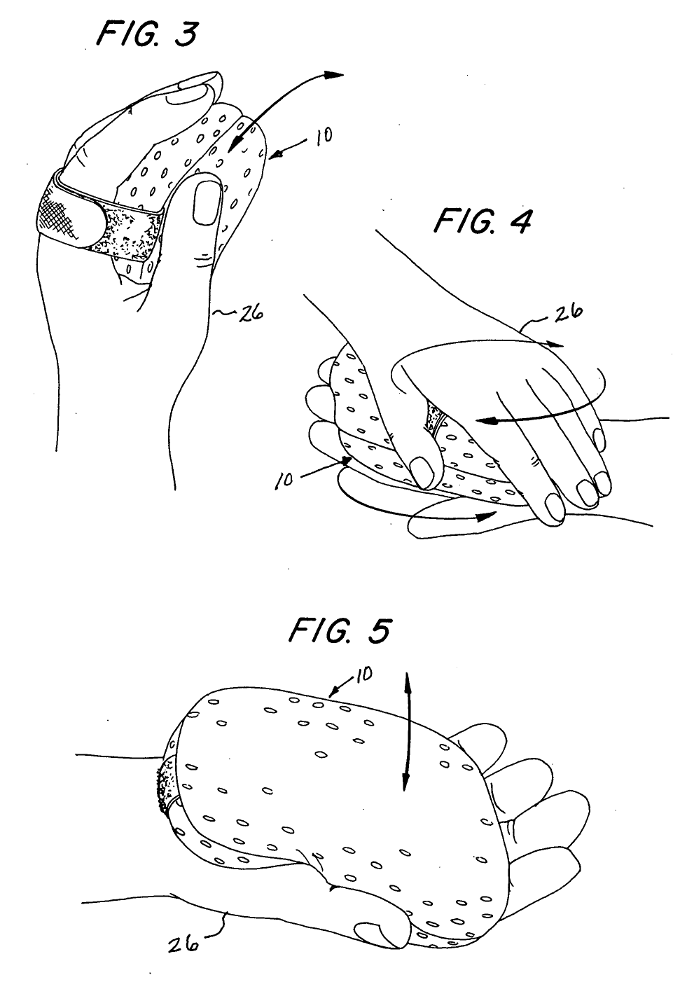

As shown in FIG. 3, in another preferred embodiment, the user holds the tactile device 10 in a closed position in one hand 26, shaking the tactile device 10 producing a sound similar to a muted shaker, and by opening and closing the hand produces a rhythmic sound or rhythmic vibration. The plurality of openings or meshes 16 provides fluid communication between the aforementioned different sounds and surrounding atmosphere.

Referring now to FIG. 4, another different sound can be obtained when the user cups the tactile device 10 in both hands 26 while simultaneously shaking and rotating the tactile device producing a sound comparable to an afuche cabasa and by applying an appropriate amount of pressure can additionally produce a sound similar to a rain stick.

Lastly, as shown in FIG. 5, in another preferred embodiment, the user holds the tactile device 10 in an open position in one hand 26, tumbling the tactile device 10 in a back and forth fashion producing a sound similar to a shakree, and although not shown may use both hands 26 to produce said sounds.

Although not shown, the tactile device 10 may be attached to any limb or appendage of the user and by varying the body movement of the limb or appendage produce a variety of different sounds and vibrations. This is especially useful to therapists who work with severely autistic children who have a hard task of connecting their patient's hand function with their brain. It should be understood that limb means any body part such as leg, wrist, ankle, arm and the like and appendage generally refers to amputated limbs.

It should be understood that the musically pleasing sound producing members 18 may be either clear crystal marbles, rose teak balls or steel ball bearings. Additionally, if the user desires, the size of the sound members 18 may be interchanged to achieve different musical ranges or provide a variety of vibrations. There has been described and illustrated herein an improved tactile device which will produce sounds equivalent to a wide range of musical devices including a muted shaker, afuche cabaso, maracus, rain stick, muted shaker as well as other tactile stimulation.

The scope of the invention is, therefore, indicated by the appended claims, rather than by the foregoing description. All changes which come within the meaning and range of equivalency of the claims are to be embraced within their scope.

What is claimed is:

1. A tactile device for use within hands of a user, comprising:
a flexible mesh housing;
a plurality of musically-pleasing sound producing members housed within said flexible mesh housing wherein movement of said flexible mesh housing causes said musically-pleasing sound producing members to impinge upon each other in a specific fashion by utilizing different movements between the user's hand to produce different acoustical sounds and vibrations.

2. A tactile device according to claim 1, wherein said musically-pleasing sound producing members are made of crystal clear glass marbles.

3. A tactile device according to claim 1, wherein said musically-pleasing sound producing members are made of stainless steel bearings.

4. A tactile device according to claim 1, wherein said flexible mesh housing is closed by hook and strap means for access to said musically-pleasing sound members.

5. A tactile device according to claim 1, wherein said flexible mesh housing is cloth.

6. A tactile device according to claim 1, wherein a strap member is affixed to said flexible mesh housing, said strap member having adjustable means.

7. A tactile device according to claim 1, wherein a strap member is affixed to said flexible mesh housing, said strap member having hook and strap means.

8. A tactile device according to claim 1, wherein movement of said flexible mesh housing by sliding back and forth between the user's hands causes said musically-pleasing sound producing members to produce a maracus sound.

9. A tactile device according to claim 1, wherein movement of said flexible mesh housing by shaking in a closed position in the user's hand causes said musically-pleasing sound producing members to produce a muted shaker sound.

10. A tactile device according to claim 1, wherein movement of said flexible mesh housing by simultaneously shaking and rotating between the user's hands causes said musically-pleasing sound producing members to produce an afuche cabasa sound.

11. A tactile device according to claim 1, wherein movement of said flexible mesh housing by tumbling back and forth in an open position in the user's hand causes said musically pleasing sound producing members to produce a shakree sound.

12. A tactile device, comprising:
a flexible mesh housing formed by individual filaments; said individual filaments connected to one another at spaced points of attachment to form a plurality of openings, wherein a plurality of musically-pleasing sound producing members are contained.

13. A tactile device according to claim 12, wherein a strap member is affixed to said flexible mesh housing, said strap member having adjustable means.

14. A tactile device according to claim 13, wherein said flexible mesh housing is affixed to a users appendage using said strap member wherein moving the user's appendage produces sounds and vibrations resulting in tactile stimulation.

15. A tactile device according to claim 13, wherein said flexible mesh housing is affixed to a users limb using said strap member wherein moving the user's limb produces sounds and vibrations resulting in tactile stimulation.

16. A tactile device according to claim 12, wherein movement of said flexible mesh housing by sliding back and forth between the user's hands causes said musically-pleasing sound producing members to produce a maracus sound.

17. A tactile device according to claim 12, wherein movement of said flexible mesh housing by shaking in a closed position in said user's hand causes said musically-pleasing sound producing members to produce a muted shaker sound.

18. A tactile device according to claim 12, wherein movement of said flexible mesh housing by simultaneously shaking and rotating between said user's hands causes said musically-pleasing sound producing members to produce an afuche cabasa sound.

19. A tactile device according to claim 12, wherein movement of said flexible mesh housing by tumbling back and forth in an open position in said user's hand causes said musically-pleasing sound producing members to produce a shakree sound.

20. A tactile device comprising:
a flexible mesh housing forming a plurality of openings; a plurality of musically-pleasing sound producing members housed within said flexible mesh housing and said flexible mesh housing is closed by hook and strap means for access to said musically-pleasing sound members wherein a strap member is affixed to said flexible mesh housing, said strap member having adjustable means, wherein movement of said flexible mesh housing causes said musically-pleasing sound producing members to produce different sounds and vibrations for tactile stimulation.
